(19) United States
(12) Patent Application Publication
(10) Pub. No.: US 2025/0389371 A1
(43) Pub. Date: Dec. 25, 2025

(54) Video Panel Stand And Method

(71) Applicant: O'Neil Kukla, LLC, Cold Spring, KY (US)

(72) Inventor: Glenn D. Kukla, Cold Spring, KY (US)

(21) Appl. No.: 19/246,880

(22) Filed: Jun. 24, 2025

Related U.S. Application Data
(60) Provisional application No. 63/663,415, filed on Jun. 24, 2024.

(51) Int. Cl. F16M 11/04; F16M 11/22

(52) U.S. Cl. CPC F16M 11/046; F16M 11/22

(57) ABSTRACT

A video panel stand for holding a video panel is disclosed. The video panel stand includes a base plate, at least one upright member coupled to the base plate, an upper control arm pivotably connected to the at least one upright member, a lower control arm pivotably connected to the at least one upright member, a frame configured to hold a video panel and operatively connected the upper control arm and the lower control arm, and a frame-height adjustment member operatively coupled to the upper control arm. When the frame-height adjustment member is operated in a first direction, the frame moves upwardly relative to the base plate and when the frame-height adjustment member is operated in a second direction, the frame moves downwardly relative to the base plate. A method of repositioning a video panel secured to a video panel stand is also disclosed.

### CROSS REFERENCE TO RELATED APPLICATION

This application claims the benefit of U.S. Provisional Patent Application Ser. No. 63/663,415, filed Jun. 24, 2024, the disclosure of which is incorporated by reference herein in its entirety.

### TECHNICAL FIELDS

The invention relates generally to a device for holding a video panel and, more specifically, an articulating video panel stand and method of using it.

### BACKGROUND

Video panels or monitors are commonly used in a variety of events and venues such as conventions, conferences, plays, musicals, and concerts, for example. Typically, a video panel is attached to a stand of some sort that is supported by the floor. Before the video panel may be used, however, the stand must be assembled which may required a plurality of tools and fasteners. Once the stand is assembled the video panel must be attached to the stand, which may also require a plurality of tools and fasteners. Another drawback of traditional stands is the lack of adjustability. For example, the stand may not be adjustable such that the stand cannot position the video panel at a desired height.

When the event is over, the video panel must be removed from the stand and the stand disassembled. This disassembly process also requires a plurality of tools and the removal of fasteners. In the end, the video panels, the stand, including the fasteners must be properly stored so they are not damaged and may be readily re-used again. Moreover, the tools must be ready and accessible any time the stand needs to be assembly or disassembled.

The assembly and disassembly of a single stand and video panel may take tens of minutes. If an event requires multiple video panels, then the overall time to assembly and disassembly multiple video panels and the corresponding stands may take well over an hour and perhaps even several hours.

What is needed therefore is a video panel stand that addresses the issues described above.

### SUMMARY OF THE INVENTION

According to one aspect of the disclosure, a video panel stand for holding a video panel according to an embodiment of the disclosure includes a base plate, a first upright member, a second upright member, and a third upright member where each upright member is coupled to and extending from the base plate. The video panel stand also includes an upper control arm having a first end and a second end where the second end is pivotably connected to the third upright member and a lower control arm having a first end and a second end where the second end is pivotably connected to the third upright member. The video panel stand also includes a frame configured to hold a video panel where the frame is connected to the first end of the upper control arm and the first end of the lower control arm and a frame-height adjustment member having an upper end and a lower end where the lower end is operatively coupled to the upper control arm. When the frame-height adjustment member is operated in a first direction, the frame moves upwardly relative to the base plate and when the frame-height adjustment member is operated in a second direction, the frame moves downwardly relative to the base plate.

In an embodiment, the video panel stand may further include a connection member having a first portion and a second portion where the first portion is coupled to the third upright member and the second portion is coupled to the first and second upright members. The upper end of the frame-height adjustment member is operatively coupled to the connection member. The frame-height adjustment member may include a threaded portion which threadingly engages the connection member. The connection member may include a nut for threadingly receiving the threaded portion of the frame-height adjustment member such that when the frame-height adjustment member is operated the threaded portion moves up or down relative to the connection member.

In an embodiment, the lower control arm is configured to move up or down as the frame moves up or down.

In an embodiment, the frame-height adjustment member may include a threaded portion with a stop nut positioned thereon at a selectable distance from the upper control arm. The stop nut is configured to stop the rise of the upper control arm and the frame at a predetermined height above the base plate.

In an embodiment, the base plate may include a pair of spaced-apart slots on opposing edges of the base plate where each slot is configured to receive an upright member of another video panel stand so that the another video panel stand may be positioned on the base plate.

In an embodiment, at least one of the first and second upright members includes a tab configured to prevent the frame from moving rearwardly beyond the first and second upright members. At least one of the first and second upright members may also include an alignment tab configured to limit lateral movement of another video panel positioned on the base plate of the video panel stand.

In an embodiment, the frame-height adjustment member may include a tool coupling member coupled to the lower end of the frame-height adjustment member where the tooling coupling member is configured to receive a tool to operate the frame-height adjustment member in both the first direction and the second direction.

According to another aspect of the disclosure, a video panel stand for holding a video panel includes a base plate, at least one upright member coupled to and extending from the base plate, and an upper control arm having a first end and a second end, the second end is pivotably connected to the at least one upright member and a lower control arm having a first end and a second end where the second end is pivotably connected to the at least one upright member. The video panel stand further includes a frame configured to hold a video panel where the frame is connected to the first end of the upper control arm and the first end of the lower control arm and a frame-height adjustment member having an upper end and a lower end where the lower end is operatively coupled to the upper control arm. When the frame-height adjustment member is operated in a first direction, the frame moves upwardly relative to the base plate and when the frame-height adjustment member is operated in a second direction, the frame moves downwardly relative to the base plate.

In an embodiment, the video panel stand may include a connection member coupled to the at least one upright member. The upper end of the frame-heigh adjustment member is operatively coupled to the connection member. The frame-height adjustment member may include a threaded portion which threadingly engages the connection member. The connection member may include a nut for threadingly receiving the threaded portion of the frame-height adjustment member such that when the frame-height adjustment member is operated the threaded portion moves up or down relative to the connection member. The frame-height adjustment member may include a threaded portion having a stop nut positioned thereon at a selectable distance from the upper control arm. The stop nut is configured to stop the rise of the upper control arm and the frame at a predetermined height above the base plate.

In an embodiment, the base plate may include a pair of spaced-apart slots on opposing edges of the base plate where each slot is configured to receive an upright member of another video panel stand so that the another video panel stand may be positioned on the base plate.

In an embodiment, the frame-height adjustment member includes a tool coupling member coupled to the lower end of the frame-height adjustment member. The tooling coupling member is configured to receive a tool to operate the frame-height adjustment member in both the first direction and the second direction.

In another aspect of the disclosure, a method of repositioning a video panel secured to a video panel stand includes providing a video panel stand including a base plate, at least one upright member couple to and extending from the base plate, an upper control arm pivotably connected to the at least one upright member, a lower control arm having pivotably connected to the at least one upright member, a frame holding a video panel, the frame being connected to the upper control arm and the lower control arm, and a frame-height adjustment member operatively connected to the upper control arm. The method further includes operating the frame-height adjustment member in a first direction such that the frame and video panel move upwardly relative to the base plate.

In an embodiment, the method further includes operating the frame-height adjustment member in a second direction such that the frame and video panel move downwardly relative to the base plate.

In an embodiment, the frame-height adjustment member includes a stop nut and the method further adjusting the stop nut along the frame-height adjustment member to a predetermined position and operating the frame-height adjustment member in a first direction until the upper control arm contacts the stop nut to thereby block the upper control arm from moving any further upwardly.

### BRIEF DESCRIPTION OF THE DRAWINGS

The accompanying drawings, which are incorporated in and constitute a part of this specification, illustrate one or more embodiments of the present disclosure and, together with a general description of the invention given above, and the detailed description given below, serve to explain the present disclosure.

FIG. 1A is a partially disassembled, front perspective view of a video panel stand according to an embodiment of the present disclosure with a video panel positioned to be mounted on the stand.

FIG. 1B is front perspective view of the video panel stand of FIG. 1A with the video panel mounted to the stand.

FIG. 2 is a rear perspective view of the video panel stand of FIG. 1B.

FIG. 3 is an enlarged, rear perspective view of an upper section of the video panel stand of FIG. 1B.

FIG. 4 is an enlarged front, perspective view of a middle section of the video panel stand of FIG. 1B with the video panel not shown.

FIG. 5 is an enlarged, rear perspective view of a lower section of the video panel stand of FIG. 1B.

FIG. 6 is a plan view of the video panel stand of FIG. 1B.

FIG. 7 is a front, elevation view of the video panel stand of FIG. 1B with the frame in the lower-most, vertical position.

FIG. 8 is a rear, elevation view of the video panel stand of FIG. 7.

FIG. 9 is a left, elevation view of the video panel stand of FIG. 7.

FIG. 10 is a right, elevation view of the video panel stand of FIG. 7.

FIG. 11 is a front, perspective view of the video panel stand of FIG. 7 with the frame raised to a mid-height, vertical position.

FIG. 12 is a rear, perspective view of the video panel stand of FIG. 7 with the panel frame raised to a mid-height, vertical position.

FIG. 13 is a front, perspective view of the video panel stand of FIG. 7 with the frame raised to a full-height, vertical position.

FIG. 14 is a rear, perspective view of the video panel stand of FIG. 7 with the panel frame raised to a full-height, vertical position.

FIG. 15 is a perspective view of two video panel stands interlocked together for transport as a single unit.

### DETAILED DESCRIPTION OF THE INVENTION

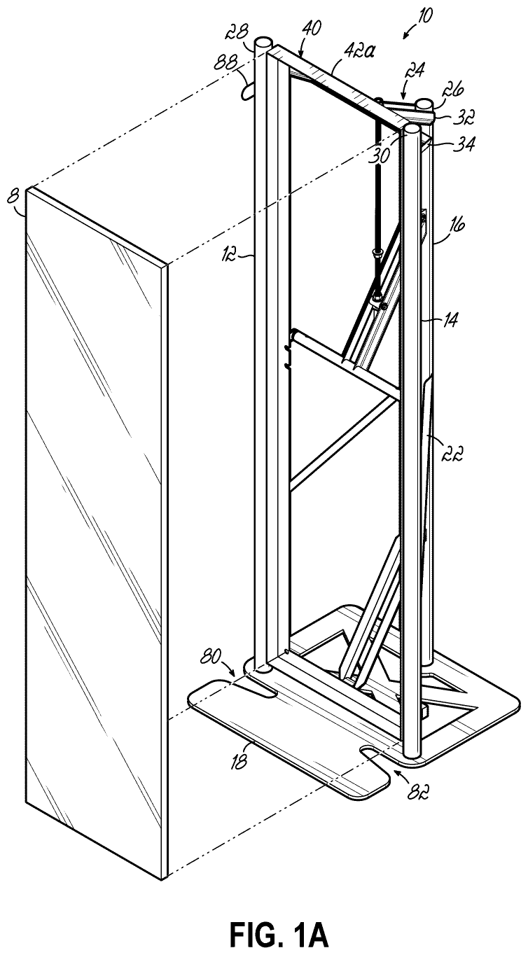

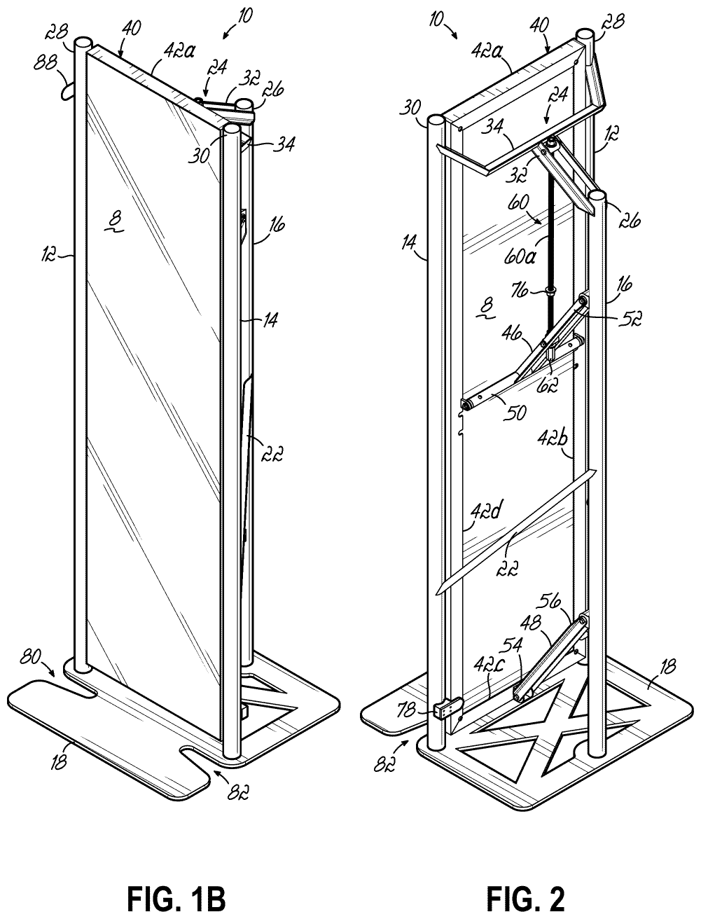

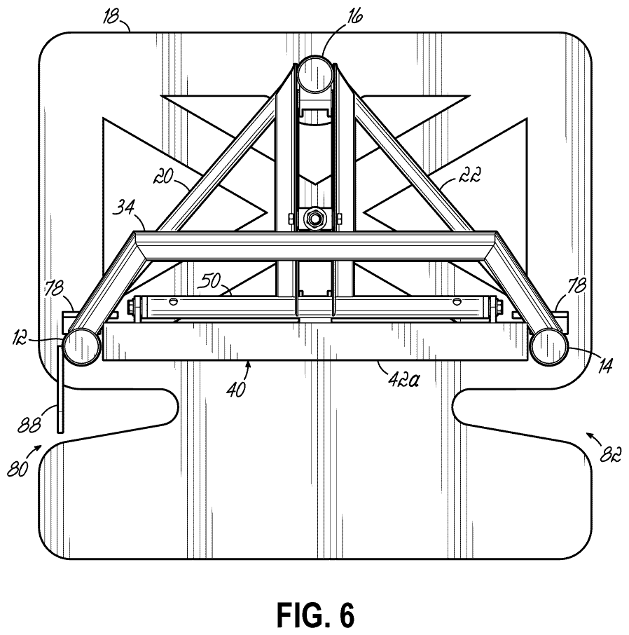

A video panel stand 10 according to one embodiment of the present disclosure is shown in FIG. 1A. The video panel stand 10 is configured to receive and hold a video panel 8, which is shown in FIG. 1A ready to be mounted on the video panel stand 10. With further reference to FIGS. 1A, 1B, and 2-6, the video panel stand 10 has three upright members 12, 14, 16 affixed to a base plate 18. Two stabilizing members 20, 22 extend from the upright member 16 to upright members 12, 14, respectively. A connection member 24 extends from an upper portion 26 of the upright member 16 to upper portions 28, 30 of upright members 12, 14, respectively. The connection member 24 includes a first portion 32 and a second portion 34. Although the first portion 32 is generally straight and the second portion 34 is generally U-shaped, the first and second portions 32, 34 may be of any suitable shapes so long as they serve to connect the upper portion 26 of upright member 16 to the upper portions 28, 30 of upright members 12, 14.

The video panel stand 10 further includes a frame 40 comprised on four frame side members 42a, 42b, 42c, 42d. The frame 40 is rectangular so has to hold video panel 8 which is also rectangular, but the frame 40 may be any shape suitable to hold a video panel with a different shape, such as square, hexagonal, or circular, for example. The frame side members 42a, 42b, 42c, 42d may have a L-shaped cross-section or any other cross-sectional shape suitable to receive and hold the video panel 8 as shown in FIG. 1B. The frame 40 is connected to the upright member 16 via an upper control arm 46 and a lower control arm 48. A first end 50 of the upper control arm 46 is pivotably connected to frame side members 42b, 42d and a second end 52 of the upper control arm 46 is pivotably connected to upright member 16. A first end 54 of the lower control arm 48 is pivotably connected to frame side member 42c and a second end 56 of the lower control arm 48 is pivotably connected to the upright member 16. See also FIG. 5.

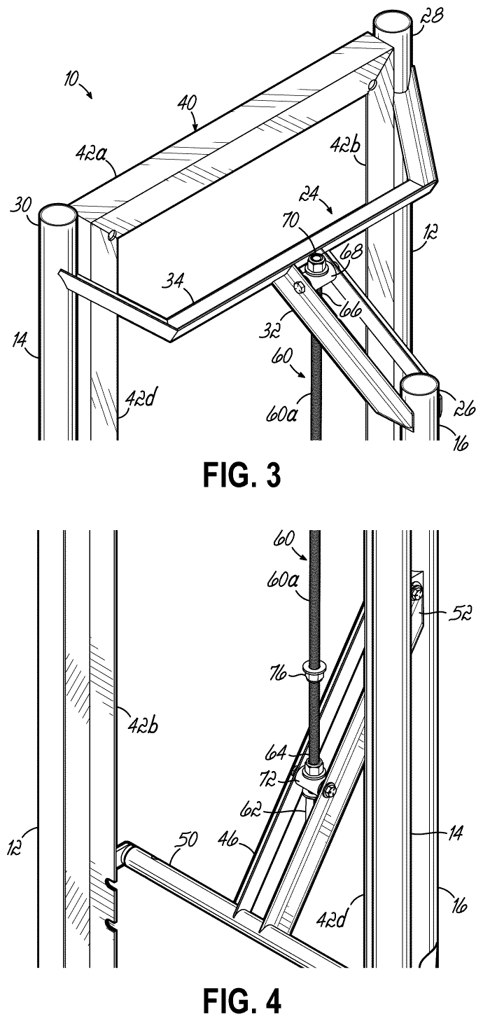

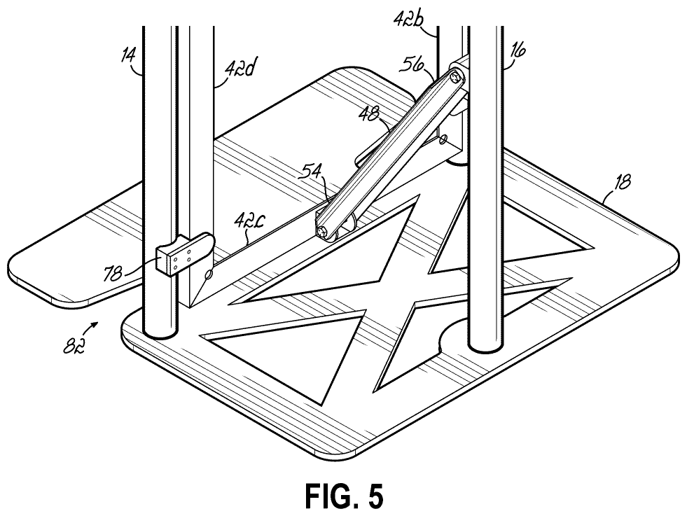

The video panel stand 10 may include a frame-height adjustment member 60 that extends between the upper control arm 46 and the first portion 32 of the connection member 24 as shown in FIG. 2. See also FIGS. 3 and 4. In an embodiment, the frame-height adjustment member 60 may a threaded rod. The frame-height adjustment member 60 includes a tool coupling member 62 at a lower end 64 of the frame-height adjustment member 60. An upper end 66 (FIG. 3) of the frame-height adjustment member 60 extends through a coupler 68 and threadingly engages a nut 70 which is affixed to the top portion of the coupler 68. The lower end 64 of the frame-height adjustment member 60 engages a coupler 72. When a tool (not shown), such as a wrench or drill, is coupled to the tool coupling member 62 and rotates the frame-height adjustment member 60, the frame-height adjustment member 60 moves relative to the nut 70 on coupler 68. If the frame-height adjustment member 60 is rotated in one direction, the frame-height adjustment member 60 will move upwardly through the nut 70 causing the coupler 72 and the upper control arm 46 to also move upwardly. If the frame-height adjustment member 60 is rotated in the opposite direction, the frame-height adjustment member 60 will move downwardly through the nut 70 causing the coupler 72 and the upper control arm to also move downwardly. For example, if the tool coupling member 62 is rotated clockwise (as viewed from below), the frame-height adjustment member 60 will move upwardly through coupler 68 and nut 70 causing the upper control arm 46 to pivot upwardly, thereby causing the frame 40 and lower control arm 48 to move upwardly. In contrast, if the tool coupling member 62 is rotated counterclockwise (as view from below), the frame-height adjustment member 60 will move downwardly through coupler 68 and nut 70 causing the upper control arm 46 to pivot downwardly, thereby causing the frame 40 and the lower control arm 48 to move downwardly.

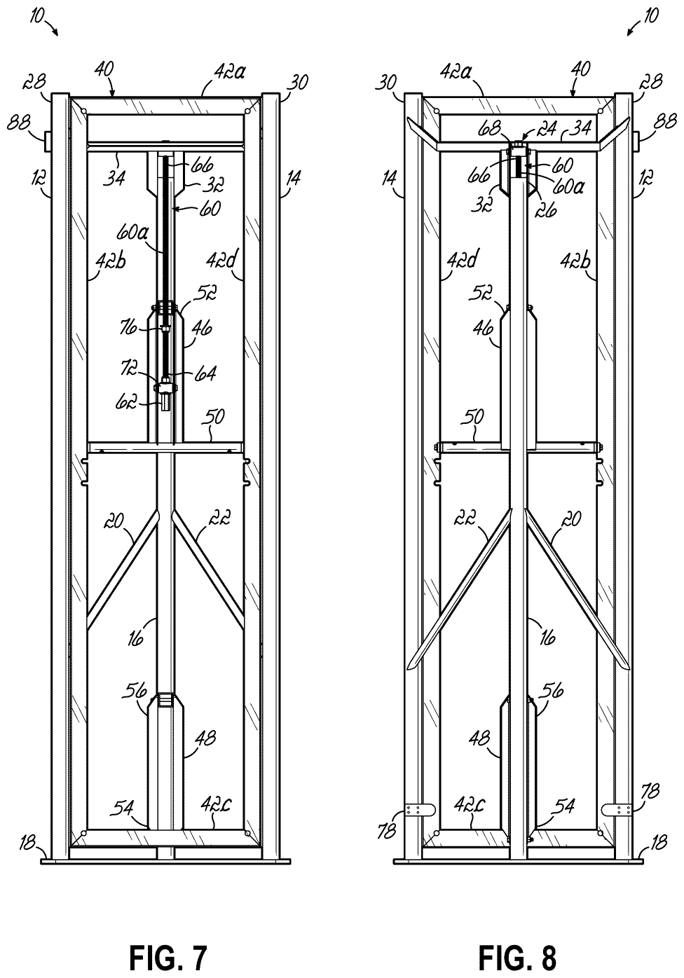

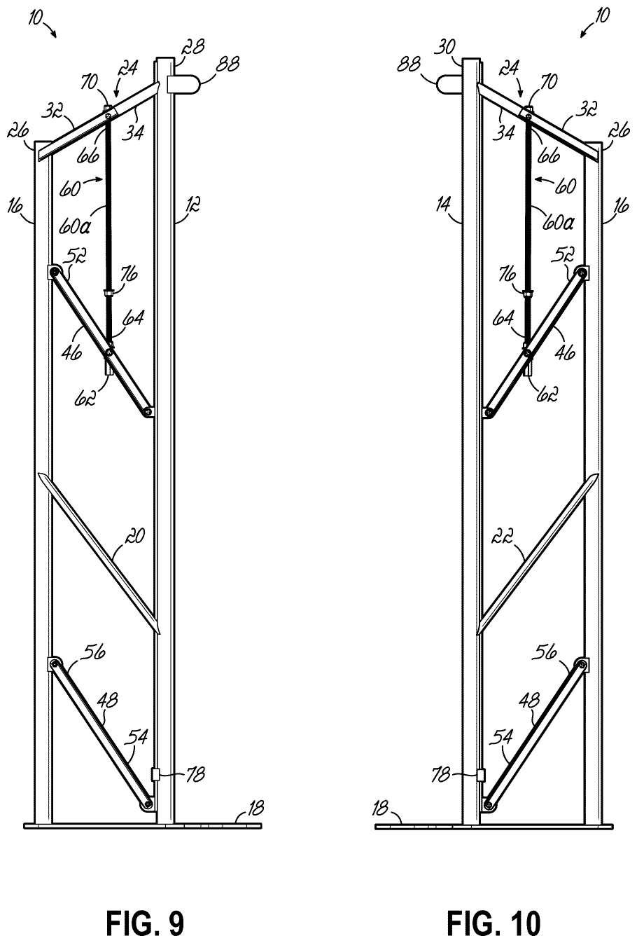

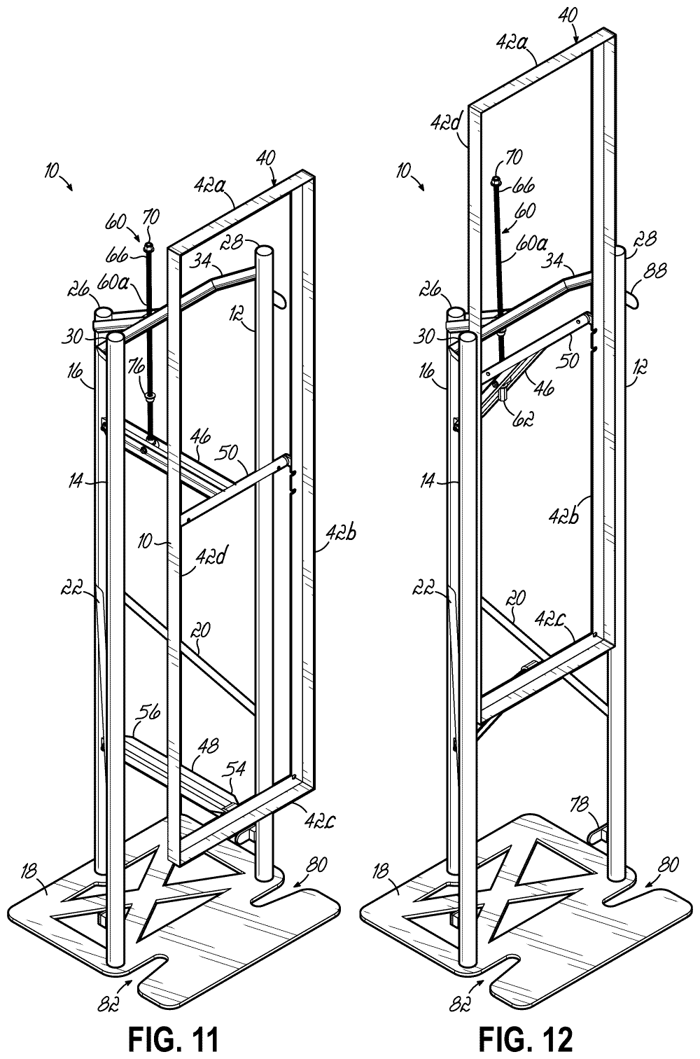

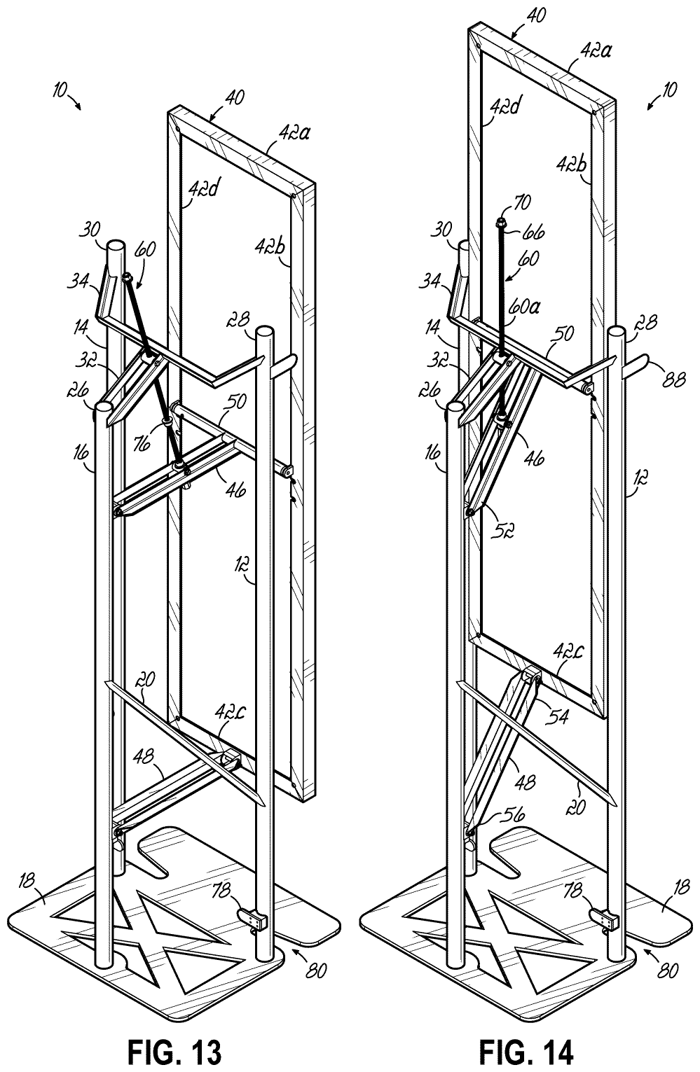

FIGS. 7-10 show the video panel stand 10 with the frame 40 in the lower-most vertical position. In this configuration, the upper end 66 of the adjustment member is shown right at the coupler 68 and nut 70. FIGS. 11-12 show the video panel stand 10 with the frame in a mid-height, vertical position. In this configuration, about a third of the frame-height adjustment member 60 extends above the coupler 68 and nut 70. FIGS. 13-14 show the video panel stand 10 with the frame in a upper-most, vertical position. In this configuration, about a half of the frame-height adjustment member 60 extends above the coupler 68 and nut 70. A stop nut 76 may be selectively positioned along a threaded portion the frame-height adjustment member 60 at any desired position between couplers 68, 72. The stop nut 76 is configured to block the coupler 72 such that the frame 40 cannot move any further upwardly. The stop nut 76 may be placed a desired location so that the frame may be deployed at a desired vertical height on a consistent and repeatable basis. Tabs 78 affixed to the lower ends of upright members 12, 14 are configured stop the frame 40 from moving rearwardly beyond the upright members 12, 14.

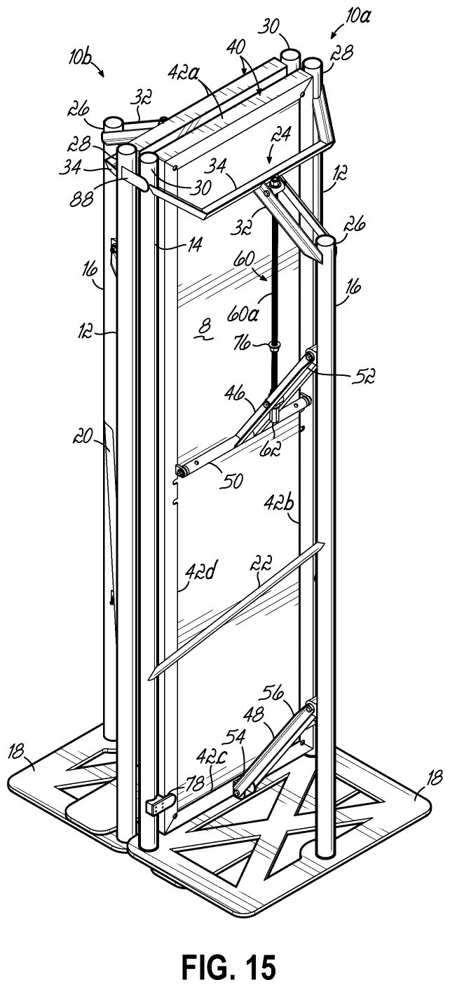

With reference to FIGS. 1, 2, and 15, the base plate 18 includes opposing slots 80, 82. The slots 80, 82 are configured to receive the upright members 12, 14 of another (second) video panel stand 10, when the two video panel stands 10 arranged so that the video panels 8 are facing one another as shown in FIG. 15. To achieve interlocking base plates 18 of two video panel stands 10a, 10b in FIG. 15, the slot 82 of video panel stand 10a is slid laterally around the upright member 12 of video panel stand 10b. The base plate 18 of video panel stand 10a is then rotated around so that the slot 82 of video panel stand 10a is aligned with the upright member 14 of video panel stand 10b. The base plate 18 of video panel stand 10a is then slid laterally over the base plate 18 of video panel stand 10b so that the side edges of the base plates 18 are substantially aligned with one another. In an embodiment, a padding material, such as egg crate foam, may be placed between the two video panel stands 10a, 10b and one or more straps, ropes, bungee cords, or the like may be used to tie the two video panel stands 10a, 10b together to facilitate transporting them as a unit via a dolly, for example.

In addition to being held together by one or more straps, the video panel stands 10a, 10b may include one or more alignment tabs 88 (FIGS. 1A and 15) affixed to either or both of the upper portions 28, 30 of the upright members 12, 14. The alignment tabs 88 are configured to keep the upright members 12, 14 of two video panel stands 10a, 10b from moving laterally when arranged as shown in FIG. 15, especially when two video panel stands 10a, 10b are being moved together. Alternatively, instead of using alignment tabs 88, the two video panel stands 10a, 10b may be held together by toggle latch clamps, C-clamps, spring clamps, bar clamps, and the like.

In use, the video panel 8 is mounted to the frame 40 with appropriate fasteners. The video inputs and the power cable on the back on the video panel and are fully accessible from through the back side of the frame 40. The video panel 8 may remain mounted to the frame 40 throughout the life of the video panel stand 10, whether it be during storage, transport, or use on stage. Moreover, two video panel stands 10a, 10b may be strapped together (FIG. 15) so they may be efficiently stored and transported. When the pair of video panel stands 10a, 10b are brought to a staging area, the strap is removed and video panel stand 10a is disengaged from video panel stand 10b. The video panel stands 10a, 10b are placed in their desired locations and an electric drill, for example, is used to rotate the frame-height adjustment member 60 so as to place the video panels 8 in their desired vertical positions. The stop nut 76 previously set a desired vertical position aids in quickly and efficiently moving the video panel 8 to the desired vertical position. The video inputs and power cords may then be plugged into the video panels 8. In just a matter of minutes the video panels 8 are ready to use.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A video panel stand for holding a video panel, comprising:
a base plate;
a first upright member, a second upright member, and a third upright member, each upright member being coupled to and extending from the base plate;
an upper control arm having a first end and a second end, the second end being pivotably connected to the third upright member;
a lower control arm having a first end and a second end, the second end being pivotably connected to the third upright member;
a frame configured to hold a video panel, the frame being connected to the first end of the upper control arm and the first end of the lower control arm; and
a frame-height adjustment member having an upper end and a lower end, the lower end being operatively coupled to the upper control arm,
wherein when the frame-height adjustment member is operated in a first direction, the frame moves upwardly relative to the base plate and when the frame-height adjustment member is operated in a second direction, the frame moves downwardly relative to the base plate.

2. The video panel stand of claim 1, further comprising:
a connection member having a first portion and a second portion, the first portion being coupled to the third upright member and the second portion being coupled to the first and second upright members,
wherein the upper end of the frame-height adjustment member is operatively coupled to the connection member.

3. The video panel stand of claim 2, wherein the frame-height adjustment member includes a threaded portion which threadingly engages the connection member.

4. The video panel stand of claim 3, wherein the connection member includes a nut for threadingly receiving the threaded portion of the frame-height adjustment member, wherein when the frame-height adjustment member is operated the threaded portion moves up or down relative to the connection member.

5. The video panel stand of claim 1, wherein the lower control arm is configured to move up or down as the frame moves up or down.

6. The video panel stand of claim 1, wherein the frame-height adjustment member includes a threaded portion having a stop nut positioned thereon at a selectable distance from the upper control arm, the stop nut configured to stop the rise of the upper control arm and the frame at a predetermined height above the base plate.

7. The video panel stand of claim 1, wherein the base plate includes a pair of spaced-apart slots on opposing edges of the base plate, each slot configured to receive an upright member of another video panel stand so that the another video panel stand may be positioned on the base plate.

8. The video panel stand of claim 1, wherein at least one of the first and second upright members includes a tab configured to prevent the frame from moving rearwardly beyond the first and second upright members.

9. The video panel stand of claim 1, wherein at least one of the first and second upright members include an alignment tab configured to limit lateral movement of another video panel stand positioned on the base plate of the video panel stand.

10. The video panel stand of claim 1, wherein the frame-height adjustment member includes a tool coupling member coupled to the lower end of the frame-height adjustment member, the tool coupling member is configured to receive a tool to operate the frame-height adjustment member in both the first direction and the second direction.

11. A video panel stand for holding a video panel, comprising:
a base plate;
at least one upright member coupled to and extending from the base plate;
an upper control arm having a first end and a second end, the second end being pivotably connected to the at least one upright member;
a lower control arm having a first end and a second end, the second end being pivotably connected to the at least one upright member;
a frame configured to hold a video panel, the frame being connected to the first end of the upper control arm and the first end of the lower control arm; and
a frame-height adjustment member having an upper end and a lower end, the lower end being operatively coupled to the upper control arm,
wherein when the frame-height adjustment member is operated in a first direction, the frame moves upwardly relative to the base plate and when the frame-height adjustment member is operated in a second direction, the frame moves downwardly relative to the base plate.

12. The video panel stand of claim 11, further comprising:
a connection member coupled to the at least one upright member,
wherein the upper end of the frame-heigh adjustment member is operatively coupled to the connection member.

13. The video panel stand of claim 12, wherein the frame-height adjustment member includes a threaded portion which is threadingly engages the connection member.

14. The video panel stand of claim 13, wherein the connection member includes a nut for threadingly receiving the threaded portion of the frame-height adjustment member, wherein when the frame-height adjustment member is operated the threaded portion moves up or down relative to the connection member.

15. The video panel stand of claim 11, wherein the frame-height adjustment member includes a threaded portion having a stop nut positioned thereon at a selectable distance from the upper control arm, the stop nut configured to stop the upper control arm and the frame from moving beyond a predetermined height above the base plate.

16. The video panel stand of claim 11, wherein the base plate includes a pair of spaced-apart slots on opposing edges of the base plate, each slot configured to receive an upright member of another video panel stand so that the another video panel stand may be positioned on the base plate.

17. The video panel stand of claim 11, wherein the frame-height adjustment member includes a tool coupling member coupled to the lower end of the frame-height adjustment member, the tool coupling member is configured to receive a tool to operate the frame-height adjustment member in both the first direction and the second direction.

18. A method of repositioning a video panel secured to a video panel stand, comprising:
providing a video panel stand including:
a base plate;
at least one upright member couple to and extending from the base plate;
an upper control arm pivotably connected to the at least one upright member;
a lower control arm having pivotably connected to the at least one upright member;
a frame holding a video panel, the frame being connected to the upper control arm and the lower control arm; and
a frame-height adjustment member operatively connected to the upper control arm; and
operating the frame-height adjustment member in a first direction such that the frame and video panel move upwardly relative to the base plate.

19. The method of claim 18, further comprising:
operating the frame-height adjustment member in a second direction such that the frame and video panel move downwardly relative to the base plate.

20. The method of claim 18, wherein the frame-height adjustment member includes a stop nut and the method further comprises:
adjusting the stop nut along the frame-height adjustment member to a predetermined position; and
operating the frame-height adjustment member in a first direction until the upper control arm contacts the stop nut to thereby block the upper control arm from moving any further upwardly.
